(19) United States
(12) Patent Application Publication
(10) Pub. No.: US 2001/0053185 A1
(43) Pub. Date: Dec. 20, 2001

(54) Method and configuration for coding a digitized picture, and method and configuration for decoding a digitized picture

(76) Inventor: Andre Kaup, Hohenkirchen (DE)

Correspondence Address: LERNER AND GREENBERG, P.A., Post Office Box 2480, Hollywood, FL, 33022-2480, US

(21) Appl. No.: 09/835,347

(22) Filed: Apr. 16, 2001

Related U.S. Application Data
(63) Continuation of application No. PCT/DE99/03172, filed on Oct. 1, 1999.

(30) Foreign Application Priority Data
Oct. 16, 1998 (DE) 198 47 840.2

(51) Int. Cl. H04N 7/12

(52) U.S. Cl. 375/240.24; 375/240.18; 382/266; 382/199

(57) ABSTRACT

A method for coding a digitized picture includes the steps of providing a picture having a picture object with associated object pixels located in the picture object, dividing the picture at least partly into picture blocks, determining the picture object in the picture, determining at least one object picture block, the at least one object picture block being at least one picture block with at least one object pixel, performing the step of determining the at least one object picture block such that a relative position of an edge of an object picture block of the picture in relation to the picture corresponds to a relative position of an edge of an object picture block of a chronologically preceding picture in relation to the chronologically preceding picture, and coding the picture by using the at least one object picture block. A method for decoding a coded digitized picture as well as configurations for coding and decoding digitized pictures are also provided.

### CROSS-REFERENCE TO RELATED APPLICATION

This application is a continuation of copending International Application No. PCT/DE99/03172, filed Oct. 1, 1999, which designated the United States.

### BACKGROUND OF THE INVENTION

1.Field of the Invention

The invention relates to a configuration and a method for coding a digitized picture and to a configuration and a method for decoding a digitized picture.

Such methods and configurations for coding and decoding a digitized picture in accordance with one of the picture coding standards H.261, H.263 or MPEG2 are based on the principle of block-based picture coding. As is disclosed by J. De Lameillieure et al. in “MPEG-2-Bildcodierung für das digitale Fernsehen” [MPEG-2 picture coding for digital television] in the publication FERNSEH-UND KINO-TECHNIK, Volume 48, No. 3/1994, 1994, the method of a block-based discrete cosine transform (DCT) is used for the block-based picture coding. The picture coding standards H.261 and H.263 are further explained by D. Le Gall, “The Video Compression Standard for Multimedia Applications”, Communications of ACM, Vol. 34, No. 4, pp. 47-58, April 1991 and by G. Wallace, “The JPEG Still Picture Compression Standard”, Communications of ACM, Vol. 34, No. 4, pp. 31-44, April 1991.

A further approach to picture coding in accordance with the picture coding standard MPEG4 is what is called the principle of object-based picture coding (see J. De Lameillieure et al., “MPEG-2-Bildcodierung für das digitale Fernsehen” [MPEG-2 picture coding for digital television], in FERNSEH- UND KINO-TECHNIK, Volume 48, No. 3/1994, 1994). In the case of object-based picture coding, a picture is segmented into picture blocks or picture areas in accordance with objects occurring in a scene, and these objects are coded separately.

Components of a customary configuration for picture coding and picture decoding are shown in FIG. 1.

FIG. 1 illustrates a camera 101 which is used to record pictures. The camera 101 may be, for example, any desired analog camera 101 which records pictures of a scene and either digitizes the pictures in the camera 101 and transmits the digitized pictures to a first computer 102, which is coupled to the camera 101, or else transmits the pictures in analog form to the first computer 102. In the first computer 102, either the digitized pictures are processed or the analog pictures are converted into digitized pictures and the digitized pictures are processed.

The camera 101 may also be a digital camera 101 with which digitized pictures are recorded directly and are fed to the first computer 102 for further processing.

The first computer 102 may also be configured as a dedicated configuration which is used to carry out the method steps described below, for example as a dedicated computer card installed in a computer.

The first computer 102 should generally be understood to mean a unit which can carry out picture signal processing in accordance with the method described below, for example a mobile videophone in which picture processing can also be carried out.

The first computer 102 has a processor 104 which is used to carry out the method steps of picture coding and picture decoding that are described below. The processor 104 is coupled via a bus 105 to a memory 106 in which a picture information item is stored.

In general, the methods described below can be realized either using software or using hardware or else partly using software and partly using hardware. Once picture coding has been effected in the first computer 101 and the coded picture information has been transmitted via a transmission medium 107 to a second computer 108, the picture decoding is carried out in the second computer 108 The second computer 108 may have the same structure as the first computer 101. The second computer 108 thus also has a processor 109 which is coupled by a bus 111 to a memory 110. FIG. 2 illustrates a possible configuration in the form of a basic circuit diagram for picture coding and/or picture decoding. The configuration illustrated can be used in the context of block-based picture coding and, in some instances, as explained in more detail below, in the context of object-based picture coding. In the case of block-based picture coding, a digitized picture 201 is divided into normally square picture blocks 220 having a size of 8×8 pixels 202 or 16×16 pixels 202 and fed to the configuration 203 for picture coding.

Usually, coding information is uniquely assigned to a pixel 202, for example brightness information (luminance values) or color information (chrominance values).

In the case of block-based picture coding, a distinction is made between various picture coding modes.

In the case of “intra picture coding”, in each case the digitized picture 201 with the coding information assigned to the pixels 202 of the digitized picture 201 is coded and transmitted (I picture).

In the case of “inter picture coding”, in each case only difference picture information between two chronologically succeeding digitized pictures 201 is coded and transmitted (P picture, B picture)

The difference information is only very small if movements of picture objects in the chronologically succeeding digitized pictures 201 are small. If the movements are large, then a very large amount of difference information is produced, which is difficult to code. For this reason, as is disclosed in the above-mentioned article by J. De Lameillieure et al., “picture-to-picture” motion (motion estimation) is measured and compensated (motion compensation) prior to the determination of the difference information.

There are various methods for motion estimation and motion compensation, as are disclosed in the above-mentioned article by J. De Lameillieure et al.. For block-based picture coding, what is called a “block matching method” is usually used. It is based on comparing a picture block to be coded with reference picture blocks of a reference picture which are the same size. The sum of the absolute differences of a coding information item which is respectively assigned to each pixel is usually used as a criterion for a correspondence quality between the block to be coded and a respective reference picture block. In this way, a motion information item for the picture block, for example a motion vector, is determined, which is transmitted with the difference information.

In order to change over between intra picture coding and inter picture coding, two switch units 204 are provided. In order to carry out the inter picture coding, a subtraction unit 205 is provided in which the difference in the picture information of two chronologically succeeding digitized pictures 201 is formed. The picture coding is controlled through the use of a picture coding control unit 20G. The picture blocks 220 or difference picture blocks to be coded are in each case fed to a transform coding unit 207. The transform coding unit 207 applies transform coding, for example a discrete cosine transform (DCT), to the coding information assigned to the pixels 202.

In general, however, for the picture coding it is possible to apply any desired transform coding, for example a discrete sine transform or else a discrete Fourier transform.

Spectral coefficients are formed by the transform coding. The spectral coefficients are quantized in a quantization unit 208 and fed to a picture coding multiplexer 221 for example for channel coding and/or for entropy coding. In an internal reconstruction loop, the quantized spectral coefficients are subjected to inverse quantization in an inverse quantization unit 209 and to inverse transform coding in an inverse transform coding unit 210.

Furthermore, in the case of inter picture coding, the difference in the picture information of the two chronologically succeeding digitized pictures is added to the picture information of the respective chronologically preceding picture in an adder unit 211, taking account of the motion vector. The pictures reconstructed in this way are stored in a memory 212. A unit for motion compensation 213 is illustrated symbolically in the memory 212 in order to simplify the illustration.

Furthermore, a loop filter 214 is provided which is connected to the memory 212 and also to the subtraction unit 205.

In addition to a picture information item to be transmitted, a mode index is fed to the picture coding multiplexer 221, which index in each case specifies whether intra picture coding or inter picture coding has been performed.

Furthermore, quantization indices for the spectral coefficients are fed to the picture coding multiplexer 221.

A motion vector is assigned in each case to a picture block 220 and/or a macroblock 223 having four picture blocks 220, for example, and is fed to the picture coding multiplexer 221.

Furthermore, an information item for the activation or deactivation of the loop filter 214 is provided. After the transmission of the picture information via a transmission medium 218, the transmitted information can be decoded in a configuration 219 for decoding, which may be a computer, for example. For this purpose, a picture decoding unit 225 is provided in the configuration 219 for decoding and, for example, has the structure of a reconstruction loop of the configuration illustrated in FIG. 1.

In the case of object-based picture coding, a picture object 301 of a picture 304, as illustrated in FIG. 3, is firstly split into picture blocks 302 having a fixed size, for example 8×8 pixels 303, the pixels 303 which belong to the picture object 301 being designated as object pixels 309. The picture blocks 302 which contain at least one object pixel 309 are designated as object picture blocks 310. After this segmentation, some of the object picture blocks 310 are located completely within the picture object 301, which is bounded by an object edge 305 of the picture object 301. The object picture blocks 310 which contain at least part of the object edge 305 are also designated as edge picture blocks 306 below.

The object picture blocks 310 which are located completely within the picture object 301 after the segmentation can be coded in accordance with an abovementioned block-based transform coding using a block-based Discrete Cosine Transform (DCT). However, the edge picture blocks 306 only partly contain picture information and have to be coded using a special method.

In accordance with International Publication No. WO 98/34196, which corresponds to Published, Non-Prosecuted German Patent Application No. DE 197 03 670 A1, the picture information within the edge picture block 306 is supplemented through the use of a suitable extrapolation method to the area of the complete edge picture block 306. This procedure is referred to as “padding”. The supplemented area is then coded using a two-dimensional discrete cosine transform (DCT).

Another method for coding an edge picture block, as is disclosed in International Publication No. WO 98/34406, is shape adapted transform coding.

In the method of shape adapted transform coding in accordance with International Publication No. WO 98/34406, those pixels 303 of an edge picture block 306 of the picture object 301 which are not object pixels 309 are masked out. Orthonormalized shape adapted transform coding in accordance with International Publication No. WO 98/34406 is applied to the remaining object pixels 309.

Spectral coefficients cⱼ of the object pixels 309 to be transformed are formed according to the following specification:

$${c}_{j} = \sqrt{\frac{2}{N}} * [ \underline{DCT - N} ( p , k ) ] * {x}_{j} \qquad ( 1 )$$

where

N designates a magnitude of the picture vector which is to be transformed and in which the transforming pixels are contained;

[DCT−N(p,k)] designates a transform matrix having the size N×N;

p,k designate indices, where p,k ε [0, N−1].

The procedure in object-based picture coding has the effect that even in the case of just a slight displacement of the relative position of an object edge of the object 301 to be coded in relation to the respectively assigned picture 302 or 320 in the two chronologically succeeding pictures 304 and 320, the relative position of the object picture blocks 310 and 321 in relation to the respectively assigned picture 304 or 320 changes. This has the effect that in the case of motion estimation and motion compensation, an object picture block 310 and 321 to be coded can no longer be found in the chronologically preceding picture 320 since the object picture block 310 in the chronologically preceding picture is located on a block edge 311.

This effect means that object picture blocks 321 have to be processed with residual error picture coding in order to compensate for discontinuities in the picture information, as occur at a block edge 311. This leads to an increase in a data rate required for transmitting the pictures.

### SUMMARY OF THE INVENTION

It is accordingly an object of the invention to provide a method for picture coding, a method for picture decoding, a configuration for picture coding, and a configuration for picture decoding which overcome the above-mentioned disadvantages of the heretofore-known methods and configurations of this general type and which achieve a picture coding that is improved with regard to a required residual error picture coding and with regard to a data rate to be transmitted.

With the foregoing and other objects in view there is provided, in accordance with the invention, a method for coding a digitized picture, that includes the steps of:

providing a digitized picture having pixels, the digitized picture having at least one picture object with associated object pixels located in the at least one picture object;

dividing the digitized picture at least partly into picture blocks;

determining the at least one picture object in the digitized picture;

determining at least one object picture block, the at least one object picture block being at least one picture block with at least one object pixel;

performing the step of determining the at least one object picture block such that a relative position of an edge of an object picture block of the digitized picture in relation to the digitized picture corresponds to a relative position of an edge of an object picture block of a chronologically preceding picture in relation to the chronologically preceding picture; and

coding the digitized picture by using the at least one object picture block.

In other words, in the case of the method for coding a digitized picture for which a chronologically preceding picture exists, with pixels, which has at least one picture object with associated object pixels, the object pixels being located in the object, the picture is at least partly divided into picture blocks and the picture object is determined in the picture. Furthermore, the object picture blocks are determined, the object picture blocks being the picture blocks which have at least one object pixel. The determination of the object picture blocks is carried out in such a way that at least one relative position of an edge of an object picture block of the picture in relation to the picture corresponds to a relative position of an edge of an object picture block of the chronologically preceding picture in relation to the chronologically preceding picture. The coding is carried out using the object picture blocks.

According to another mode of the invention, a hybrid transform coding is used for the coding step.

With the objects of the invention in view there is also provided, a method for coding and for decoding a digitized picture, that includes the steps of:

performing a coding process for coding a digitized picture having pixels, the digitized picture having at least one picture object with associated object pixels located in the picture object;

performing the coding process by dividing the digitized picture at least partly into picture blocks, by determining the at least one picture object in the digitized picture, by determining at least one object picture block, the at least one object picture block being at least one picture block with at least one object pixel, by performing the step of determining the at least one object picture block such that a relative position of an edge of the at least one object picture block of the digitized picture in relation to the digitized picture corresponds to a relative position of an edge of an object picture block of a chronologically preceding picture in relation to the chronologically preceding picture, and by using the at least one object picture block for the coding process; and

performing a decoding process by using a process inverse to the coding process.

In other words, in a method for decoding a digitized picture for which a chronologically preceding picture exists, with pixels, which has at least one picture object with associated object pixels, the object pixels being located in the object, the picture is coded in the following manner:

The picture is at least partly divided into picture blocks and the picture object is determined in the picture. Furthermore, object picture blocks are determined, the object picture blocks being the picture blocks which have at least one object pixel. The determination of the object picture blocks is carried out in such a way that at least one relative position of an edge of an object picture block of the picture in relation to the picture corresponds to a relative position of an edge of an object picture block of the chronologically preceding picture in relation to the chronologically preceding picture. The coding is carried out using the object picture blocks. Furthermore, the decoding is carried out using a method which is the inverse of the coding.

In accordance with another mode of the invention, the digitized picture has a plurality of picture objects.

A further mode of the invention includes performing the step of determining the at least one object picture block such that a plurality of relative positions of an edge of an object picture block of the digitized picture in relation to the digitized picture respectively correspond to a relative position of an edge of an object picture block of the chronologically preceding picture in relation to the chronologically preceding picture.

A further mode of the invention includes using an inverse transform coding for the step of performing the decoding process.

With the objects of the invention in view there is also provided, a configuration for coding a digitized picture, including:

a processor configured to perform the following steps:

dividing a digitized picture having pixels at least partly into picture blocks, the digitized picture having at least one picture object with associated object pixels located in the at least one picture object;

determining the at least one picture object in the digitized picture;

determining at least one object picture block, the at least one object picture block being at least one picture block with at least one object pixel;

performing the step of determining the at least one object picture block such that a relative position of an edge of an object picture block of the digitized picture in relation to the digitized picture corresponds to a relative position of an edge of an object picture block of a chronologically preceding picture in relation to the chronologically preceding picture; and

coding the digitized picture by using the at least one object picture block.

In the case of the configuration for coding a digitized picture for which a chronologically preceding picture exists, with pixels, which has at least one picture object with associated object pixels, the object pixels being located in the object, a processor is provided which is set up in such a way that the following steps can be carried out:

The picture is at least partly divided into picture blocks and the picture object is determined in the picture. Furthermore, object picture blocks are determined, the object picture blocks being the picture blocks which have at least one object pixel. The determination of the object picture blocks is carried out in such a way that at least one relative position of an edge of an object picture block of the picture in relation to the picture corresponds to a relative position of an edge of an object picture block of the chronologically preceding picture in relation to the chronologically preceding picture. The coding is carried out using the object picture blocks.

According to another feature of the invention, the processor is programmed to process a picture having a plurality of picture objects.

According to yet another feature of the invention, the processor is configured to perform the step of determining the at least one object picture block such that a plurality of relative positions of an edge of an object picture block of the digitized picture in relation to the digitized picture respectively correspond to a relative position of an edge of an object picture block of the chronologically preceding picture in relation to the chronologically preceding picture.

In other words, in the case of the configuration for decoding a digitized picture for which a chronologically preceding picture exists, with pixels, which has at least one picture object with associated object pixels, the object pixels being located in the object, the picture is coded in the following manner:

The picture is at least partly divided into picture blocks and the picture object is determined in the picture. Furthermore, object picture blocks are determined, the object picture blocks being the picture blocks which have at least one object pixel. The determination of the object picture blocks is carried out in such a way that at least one relative position of an edge of an object picture block of the picture in relation to the picture corresponds to a relative position of an edge of an object picture block of the chronologically preceding picture in relation to the chronologically preceding picture. The coding is carried out using the object picture blocks. Furthermore, the configuration for decoding the digitized picture has a processor which is set up in such a way that the decoding can be carried out using a method which is the inverse of the coding.

With the objects of the invention in view there is also provided, a picture data configuration, including:

a coded digitized picture including at least one picture object having associated object pixels located in the at least one picture object; and

the coded digitized picture being generated from a digitized picture to be coded by dividing the digitized picture to be coded at least partly into picture blocks, by determining the least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block.

With the objects of the invention in view there is also provided, a computer readable medium having stored thereon a picture data structure including a coded digitized picture having at least one picture object with associated object pixels located in the at least one picture object, the coded digitized picture being generated from a digitized picture to be coded by dividing the digitized picture to be coded at least partly into picture blocks, by determining the least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block.

With the objects of the invention in view there is also provided, a method of processing picture data, that includes the steps of:

providing a coded digitized picture including at least one picture object having associated object pixels located in the at least one picture object, the coded digitized picture being generated from a digitized picture to be coded by dividing the digitized picture to be coded at least partly into picture blocks, by determining the at least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block; and

processing, decoding or transmitting the coded digitized picture.

What is particularly advantageous about the invention is that the procedure presented achieves a reduction of the residual error picture coding in the context of block-based and/or object-based picture coding for a discontinuity in the picture information, wherein the discontinuity occurs at a block edge. As a result, the quantity of data required for describing a picture is reduced.

Consequently, with the data rate remaining the same, more coding information can be transmitted. As a result, the picture quality of the transmitted pictures is increased. With the picture quality of the transmitted pictures remaining the same, the reduced quantity of data leads to a reduced data rate and hence to an improved coding efficiency.

In a preferred embodiment of the invention, a hybrid transform coding is used for the coding and/or an inverse transform coding is used for the decoding.

A preferred method which is used for the transform coding and/or inverse transform coding is a discrete cosine transform (DCT) and/or an inverse discrete cosine transform (IDCT).

Other features which are considered as characteristic for the invention are set forth in the appended claims.

Although the invention is illustrated and described herein as embodied in a method and configuration for coding a digitized picture and a method an d configuration for decoding a digitized picture, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of a configuration for picture coding and/or picture decoding having a camera, two computers and a transmission medium;

FIG. 2 is a block diagram of a configuration for block-based picture coding and picture decoding;

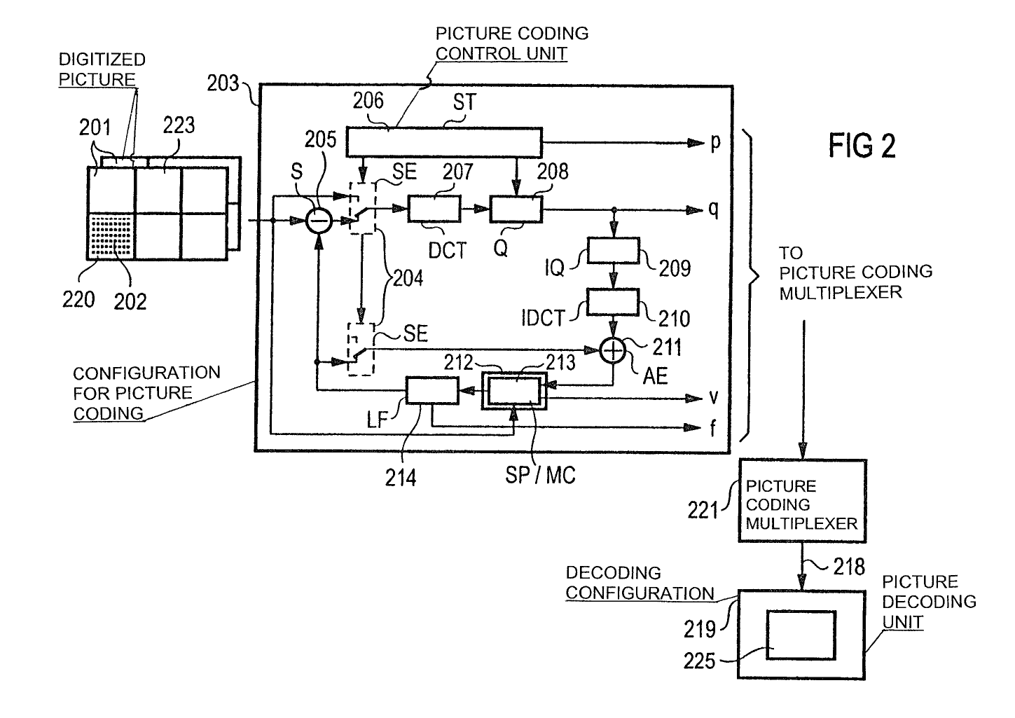

FIG. 3 is a symbolic illustration of two chronologically succeeding pictures each with a picture object, with pixels, with object pixels, with picture blocks, with object picture blocks and with edge picture blocks; and

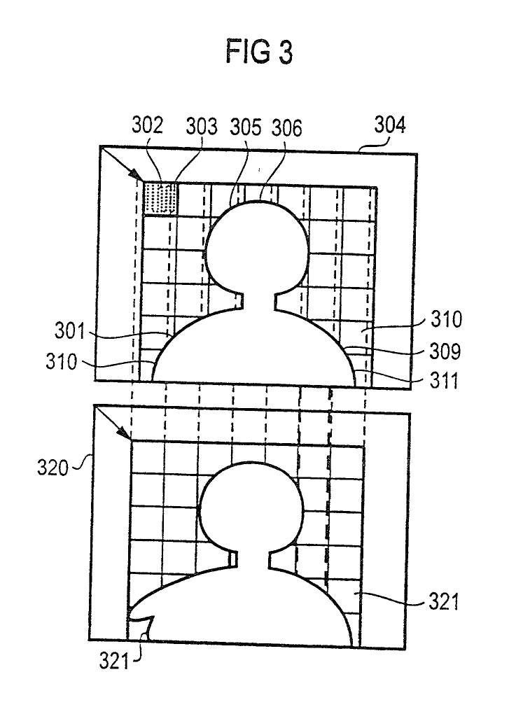

FIG. 4 is a symbolic illustration of two chronologically succeeding pictures with “fixed segmentation” of object picture blocks and picture blocks.

### DESCRIPTION OF THE PREFERRED EMBODIMENTS

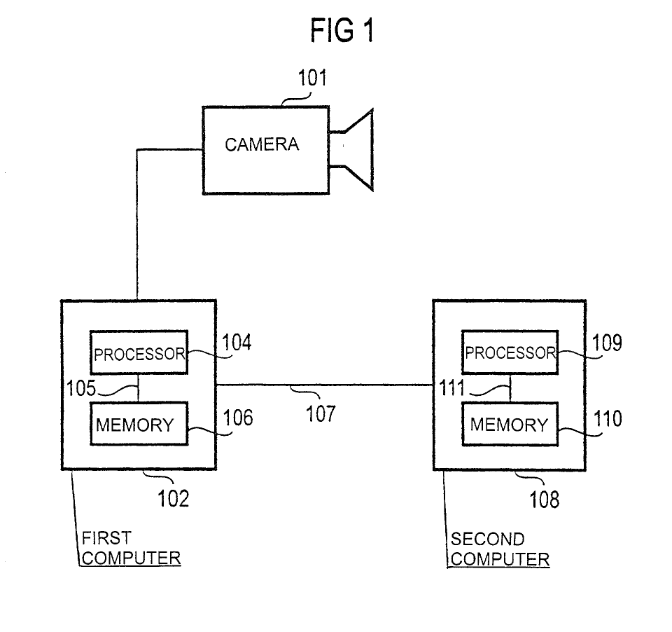

Referring now to the figures of the drawings in detail and first, particularly, to FIG. 1 thereof, there is shown a configuration for picture coding and picture decoding. FIG. 1 illustrates a camera 101 which is used to record pictures. The camera 101 is an analog camera 101 which records pictures of a scene and transmits the pictures in analog form to a first computer 102. In the first computer 102, the analog pictures are converted into digitized pictures 103 and the digitized pictures 103 are processed.

The first computer 102 is configured as a dedicated or independent configuration in the form of a dedicated computer card installed in the first computer 102, with which computer card the method steps described below are carried out.

The first computer 102 has a processor 104 which is used to carry out the method steps of picture coding that are described below. The processor unit 104 is coupled via a bus 105 to a memory 106 in which a picture information item is stored.

The method for picture coding that is described below is realized using software. It is stored in the memory 106 and is executed by the processor 104.

Once picture coding has been effected in the first computer 101 and the coded picture information has been transmitted via transmission medium 107 to a second computer 108, picture decoding is carried out in the second computer 108.

The second computer 108 has the same structure as the first computer 101. The second computer 108 also has a processor 109, which processor is coupled by a bus 111 to a memory 110.

The method for picture decoding that is described below is realized using software. It is stored in the memory 110 and is executed by the processor 109.

The method for motion estimation and the method for motion compensation, as are disclosed in International Publication No. WO 98/34406, which corresponds to Published, Non-Prosecuted Patent Application No. DE 197 03 672 A1, are used both in the context of picture coding and in the context of picture decoding.

In the context of the object-based picture coding of the digitized pictures, which are pictures of a chronological picture sequence, a digitized picture is generally subdivided (segmented) in accordance with the picture objects occurring in a scene, and the picture objects are coded separately.

This type of segmentation is carried out for the chronologically first picture of the picture sequence. The picture coding of the chronologically first picture is effected according to the intra picture coding mode.

Each picture object 301 of a picture 304 is firstly split into picture blocks 302 having a fixed size, for example 8×8 pixels 303, the pixels 303 which belong to the picture object 301 being designated as object pixels 309. The picture blocks 302 which contain at least one object pixel 309 are designated as object picture blocks 310. After this segmentation, some of the object picture blocks 310 are located completely within the picture object 301, which is bounded by an object edge 305 of the picture object 301. The object picture blocks 310 which contain at least part of the object edge 305 are also designated as edge picture blocks 306 below.

The object picture blocks 310 which are located completely within the picture object 301 after the segmentation are coded in accordance with the abovementioned block-based transform coding using a block-based Discrete Cosine Transform (DCT).

However, the edge picture blocks 306 only partly contain picture information and have to be coded using a special method.

The method for coding an edge picture block, as is disclosed in International Publication No. WO 98/34406, is a shape adapted transform coding.

In the method of shape adapted transform coding in accordance with International Publication No. WO 98/34406 (DE 197 03 672 A1), those pixels 303 of an edge picture block 306 of the picture object 301 which are not object pixels 309 are masked out. Shape adapted transform coding in accordance with International Publication No. WO 98/34406 (DE 197 03 672 A1) is applied to the remaining object pixels 309.

For the coding information of the object pixels 309, spectral coefficients cⱼ of the object pixels 309 to be transformed are formed according to the following specification:

$${c}_{j} = 2 * \frac{2}{N} * [ \underline{DCT - N} ( p , k ) ] * {x}_{j} \qquad ( 2 )$$

where

N designates a magnitude of the picture vector which is to be transformed and in which the transforming pixels are contained;

[DCT−N(p,k)] designates a transform matrix having the size N×N;

p,k designate indices, where p,k ε [0, N−1].

The shape adapted Discrete Cosine Transform (DCT) is used as the shape adapted transform coding.

For the pictures which chronologically succeed the first picture, the picture coding is carried out according to the inter picture coding mode.

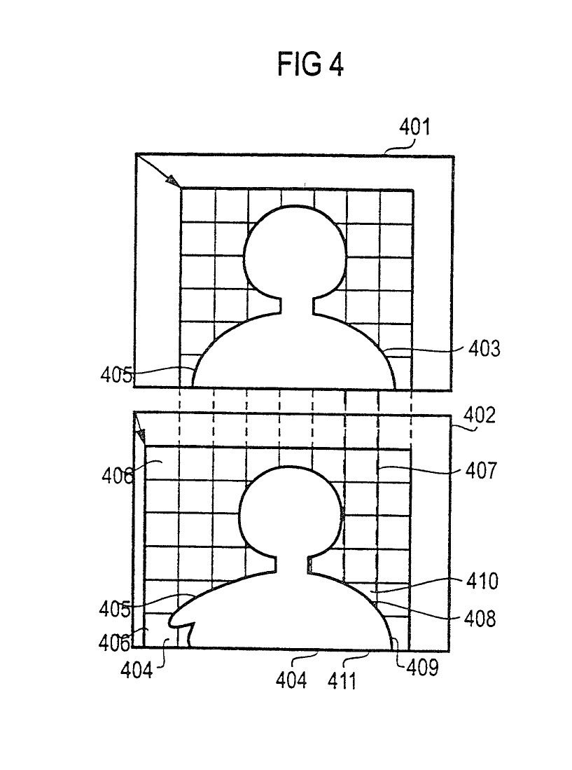

The segmentation of these pictures, which is illustrated in FIG. 4 by way of example on two chronologically succeeding pictures 401 and 402, is effected in each case in such a way that the relative position of a respective object picture block 403 of the chronologically preceding picture 401 in relation to the chronologically preceding picture 401 is identical to the relative position of a corresponding object picture block 404 of the picture 402 that is currently to be transmitted in relation to the picture 402 that is currently to be transmitted. As a result of this, there is at least partly fixed segmentation in the two chronologically succeeding pictures, the relative position of the object picture blocks 404 of the picture 402 that is currently to be transmitted in relation to the associated picture 402 being at least partly identical to the relative position of the object picture blocks 403 of the chronologically preceding picture 401 in relation to the associated picture 401.

Taking account of the size of the picture object 405 of the picture 402 that is currently to be transmitted, further picture blocks 406 and object picture blocks 404 are determined in the picture 402 that is currently to be transmitted, and/or the divided picture blocks 406 and object picture blocks 404 are adapted in the current picture 402 in such a way that the picture object 405 is completely covered by object picture blocks 404 and, moreover, all divided picture blocks 406 and object picture blocks 404 of the picture 402 that is currently to be transmitted describe a rectangular area 407.

After this segmentation of the picture 402 that is currently to be transmitted, some of the object picture blocks 404 are located completely within the picture object 405, which is bounded by an object edge 408 (object edge) of the picture object 405. The object picture blocks 404 which contain at least part of the object edge 408 are also designated as edge picture blocks 409 below.

The object picture blocks 404 which are located completely within the picture object 405 after the segmentation are coded in accordance with the abovementioned block-based transform coding using a block-based Discrete Cosine Transform (DCT).

However, the edge picture blocks 409 are only partly filled with picture information and have to be coded using a special method.

The method for coding an edge picture block 409, as is disclosed in International Publication No. WO 98/34406, is a shape adapted transform coding.

In the method of shape adapted transform coding in accordance with International Publication No. WO 98/34406, those pixels 410 of an edge picture block 409 of the picture object 405 which are not object pixels 411 are masked out. Shape adapted transform coding in accordance with International Publication No. WO 98/34406 is applied to the remaining object pixels 411.

For the coding information of the object pixels 411, spectral coefficients cⱼ of the object pixels 411 to be transformed are formed according to the following specification:

$${c}_{j} = \sqrt{\frac{2}{N}} * [ \underline{DCT - N} ( p , k ) ] * {x}_{j} \qquad ( 3 )$$

The shape adapted Discrete Cosine Transform (DCT) is used as the shape adapted transform coding.

After the transmission of the coded picture information, i.e. after quantization and entropy coding of the transmitted picture information in accordance with International Publication No. WO 98/34406 via the transmission medium 107, picture decoding is carried out.

In the case of picture decoding, entropy decoding and an inverse quantization are carried out in accordance with International Publication No. WO 98/34406.

To that end, the spectral coefficients cⱼ are fed to the inverse shape adapted transform coding (IDCT).

In the case of the inverse shape adapted transform coding in the context of picture coding in the inter picture coding mode, the object pixels xⱼ are formed from the spectral coefficients cⱼ according to the following specification (4):

$${x}_{j} = \sqrt{\frac{2}{N}} * {[ \underline{DCT - N} ( p , k ) ]}^{- 1} * {c}_{j} \qquad ( 4 )$$

where:

N designates a magnitude of the picture vector which is to be transformed and in which the transforming pixels are contained;

[DCT−N(p,k)] designates a transform matrix having the size N×N;

p,k designate indices, where p,k ε [0, N−1];

()⁻¹ designates inversion of a matrix.

In the case of the inverse shape adapted transform coding in the context of picture coding in the intra picture coding mode, the object pixels xⱼ are formed from the spectral coefficients cⱼ according to the following specification (5):

$${x}_{j} = \frac{1}{2} ** {[ \underline{DCT - N} ( p , k ) ]}^{- 1} * {c}_{j} \qquad ( 5 )$$

The decoded picture is determined using the object pixels xⱼ that have been determined.

Alternatives to the exemplary embodiment are specified below:

In a configuration for picture coding, a transform coding unit (DCT) for shape adapted transformation of the object pixels may be provided, the transform coding unit (DCT) being configured in such a way that the method steps presented in the context of the method for picture coding are realized in the transform coding unit (DCT).

In a configuration for picture decoding, an inverse transform coding unit (IDCT) for inverse shape adapted transformation of the object pixels may be provided, the inverse transform coding unit (IDCT) being configured in such a way that the method steps presented in the context of the method for picture decoding are realized in the inverse transform coding unit (IDCT).

I claim:

1. A method for coding a digitized picture, the method which comprises:
providing a digitized picture having pixels, the digitized picture having at least one picture object with associated object pixels located in the at least one picture object;
dividing the digitized picture at least partly into picture blocks;
determining the at least one picture object in the digitized picture;
determining at least one object picture block, the at least one object picture block being at least one picture block with at least one object pixel;
performing the step of determining the at least one object picture block such that a relative position of an edge of an object picture block of the digitized picture in relation to the digitized picture corresponds to a relative position of an edge of an object picture block of a chronologically preceding picture in relation to the chronologically preceding picture; and
coding the digitized picture by using the at least one object picture block.

2. The method according to claim 1, which comprises providing the digitized picture as a picture having a plurality of picture objects.

3. The method according to claim 1, which comprises performing the step of determining the at least one object picture block such that a plurality of relative positions of an edge of an object picture block of the digitized picture in relation to the digitized picture respectively correspond to a relative position of an edge of an object picture block of the chronologically preceding picture in relation to the chronologically preceding picture.

4. The method according to claim 1, which comprises using a hybrid transform coding for the coding step.

5. A method for coding and for decoding a digitized picture, the method which comprises:
performing a coding process for coding a digitized picture having pixels, the digitized picture having at least one picture object with associated object pixels located in the picture object;
performing the coding process by dividing the digitized picture at least partly into picture blocks, by determining the at least one picture object in the digitized picture, by determining at least one object picture block, the at least one object picture block being at least one picture block with at least one object pixel, by performing the step of determining the at least one object picture block such that a relative position of an edge of the at least one object picture block of the digitized picture in relation to the digitized picture corresponds to a relative position of an edge of an object picture block of a chronologically preceding picture in relation to the chronologically preceding picture, and by using the at least one object picture block for the coding process; and
performing a decoding process by using a process inverse to the coding process.

6. The method according to claim 5, which comprises providing the digitized picture as a picture having a plurality of picture objects.

7. The method according to claim 5, which comprises performing the step of determining the at least one object picture block such that a plurality of relative positions of an edge of an object picture block of the digitized picture in relation to the digitized picture respectively correspond to a relative position of an edge of an object picture block of the chronologically preceding picture in relation to the chronologically preceding picture.

8. The method according to claim 5, which comprises using an inverse transform coding for the step of performing the decoding process.

9. A configuration for coding a digitized picture, comprising:
a processor configured to perform the following steps:
dividing a digitized picture having pixels at least partly into picture blocks, the digitized picture having at least one picture object with associated object pixels located in the at least one picture object;
determining the at least one picture object in the digitized picture;
determining at least one object picture block, the at least one object picture block being at least one picture block with at least one object pixel;
performing the step of determining the at least one object picture block such that a relative position of an edge of an object picture block of the digitized picture in relation to the digitized picture corresponds to a relative position of an edge of an object picture block of a chronologically preceding picture in relation to the chronologically preceding picture; and
coding the digitized picture by using the at least one object picture block.

10. The configuration according to claim 9, wherein said processor is programmed to process a picture having a plurality of picture objects.

11. The configuration according to claim 9, wherein said processor is configured to perform the step of determining the at least one object picture block such that a plurality of relative positions of an edge of an object picture block of the digitized picture in relation to the digitized picture respectively correspond to a relative position of an edge of an object picture block of the chronologically preceding picture in relation to the chronologically preceding picture.

12. A configuration for coding and for decoding a digitized picture, comprising:
a processor configured to perform a decoding that is inverse to a coding, wherein the coding includes:
dividing a digitized picture having pixels at least partly into picture blocks, the digitized picture having at least one picture object with associated object pixels located in the at least one picture object;
determining the at least one picture object in the digitized picture;
determining at least one object picture block, the at least one object picture block being at least one picture block with at least one object pixel;
performing the step of determining the at least one object picture block such that a relative position of an edge an object picture block of the digitized picture in relation to the digitized picture corresponds to a relative position of an edge of an object picture block of a chronologically preceding picture in relation to the chronologically preceding picture; and
coding the digitized picture by using the at least one object picture block.

13. The configuration according to claim 12, wherein said processor is configured to process a picture having a plurality of picture objects.

14. The configuration according to claim 12, wherein the at least one object picture block is determined such that a plurality of relative positions of an edge of an object picture block of the digitized picture in relation to the digitized picture respectively correspond to a relative position of an edge of an object picture block of the chronologically preceding picture in relation to the chronologically preceding picture.

15. A picture data configuration, comprising:
a coded digitized picture including at least one picture object having associated object pixels located in said at least one picture object; and
said coded digitized picture being generated from a digitized picture to be coded by dividing the digitized picture to be coded at least partly into picture blocks, by determining the least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block.

16. A computer readable medium having stored thereon a picture data structure comprising:
a coded digitized picture including at least one picture object having associated object pixels located in said at least one picture object;
said coded digitized picture being generated from a digitized picture to be coded by dividing the digitized picture to be coded at least partly into picture blocks, by determining the least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block.

17. A method of processing picture data, the method which comprises:
providing a coded digitized picture including at least one picture object having associated object pixels located in the at least one picture object, the coded digitized picture being generated from a digitized picture to be coded by dividing the digitized picture to be coded at least partly into picture blocks, by determining the at least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block; and
processing the coded digitized picture.

18. A method of processing picture data, the method which comprises:
providing a coded digitized picture including at least one picture object having associated object pixels located in the at least one picture object, the coded digitized picture being generated from a digitized picture to be coded by dividing the digitized picture to be coded at least partly into picture blocks, by determining the at least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block; and
decoding the coded digitized picture.

19. A method of transmitting picture data, the method which comprises:
providing a coded digitized picture including at least one picture object having associated object pixels located in the at least one picture object, the coded digitized picture being generated from a digitized picture to be coded by dividing the digitized picture to be coded at least partly into picture blocks, by determining the at least one picture object in the digitized picture to be coded, by determining an object picture block, the object picture block having at least one object pixel and being determined such that a relative position of an edge of an object picture block of the digitized picture to be coded in relation to the digitized picture to be coded corresponds to a relative position of an edge of an object picture block of a chronologically preceding picture in relation to the chronologically preceding picture, and by carrying out a coding by using the object picture block; and
transmitting the coded digitized picture.
